(19) United States
(12) Patent Application Publication
(10) Pub. No.: US 2025/0132641 A1
(43) Pub. Date: Apr. 24, 2025

(54) POWER GENERATION ELEMENT, POWER GENERATION SYSTEM, AND ENCODER

(71) Applicant: Panasonic Intellectual Property Management Co., Ltd., Osaka (JP)

(72) Inventors: SHINICHI TSUTSUMI, Kyoto (JP); MASAKI TANAKA, Nara (JP); TOMOYUKI MURANISHI, Osaka (JP); SHINICHIRO ITO, Kanagawa (JP); YU NISHITANI, Hyogo (JP)

(21) Appl. No.: 18/701,636

(22) PCT Filed: Sep. 14, 2022
(86) PCT No.: PCT/JP2022/034356

§ 371 Date: Sep. 26, 2024

(30) Foreign Application Priority Data
Nov. 2, 2021 (JP) 2021-179211

(51) Int. Cl. H02K 11/00; H02K 3/04

(52) U.S. Cl. CPC H02K 11/0094; H02K 3/04

(57) ABSTRACT

Provided is a power generation element or the like in which a power generation amount is less likely to vary. Power generation element (100) includes magnetic member (110) that produces a large Barkhausen effect because of a change in an external magnetic field, coil (130) wound around magnetic member (110), and ferrite member (150) disposed side by side with coil (130) along a winding axis direction of coil (130) and including opening (151) into which a part of magnetic member (110) is inserted. In the winding axis direction, ferrite member (150) includes end surface (152) positioned farther than end surface (111) of magnetic member (110).

### TECHNICAL FIELD

The present disclosure relates to a power generation element, a power generation system, and an encoder, and particularly relates to a power generation element, a power generation system, and an encoder using a large Barkhausen effect.

### BACKGROUND ART

Conventionally, in an encoder for detecting rotation or the like of a motor, there is known an encoder that uses a power generation element utilizing a large Barkhausen effect in order to detect rotation without using a battery (for example, PTL 1). Such a power generation element has, for example, a configuration in which a coil is wound around a magnetic member that produces a large Barkhausen effect. In a magnetic member that produces a large Barkhausen effect, a magnetic flux density rapidly changes because of a change in an external magnetic field, and thus electric power is generated in the coil wound around the magnetic member due to the rapid change in the magnetic flux density. The encoder detects rotation or the like of the motor by using an electric signal generated by such electric power.

### CITATION LIST

### Patent Literature

PTL 1: Unexamined Japanese Patent Publication No. 2012-198067

### SUMMARY OF THE INVENTION

In the power generation element using a large Barkhausen effect as described above, it is required that the power generation amount is less likely to decrease and the variation in the power generation amount is small even when the intensity of the external magnetic field applied to the power generation element changes. For example, when the power generation element is used in the encoder, the accuracy of detecting the rotation of the motor or the like deteriorates with a large variation in the power generation amount.

The present disclosure has been made to solve such a problem, and an object thereof is to provide a power generation element in which a power generation amount is less likely to vary, a power generation system including the power generation element, and an encoder including the power generation system.

To achieve the above object, a power generation element according to an aspect of the present disclosure includes a magnetic member that produces a large Barkhausen effect because of a change in an external magnetic field, a coil wound around the magnetic member, and a ferrite member disposed side by side with the coil along a winding axis of the coil and includes an opening into which a part of the magnetic member is inserted, in which the ferrite member includes an end portion positioned farther from the coil along the winding axis than an end portion of the magnetic member.

A power generation system according to an aspect of the present disclosure includes the power generation element and a magnetic field application unit that applies a magnetic field to the power generation element and repeatedly reverses a direction of the magnetic field applied to the power generation element, in which the power generation element generates power by using a reversal of the direction of the magnetic field caused by the magnetic field application unit.

An encoder according to an aspect of the present disclosure includes the power generation system, in which the power generation element outputs the power generated by using the reversal of the direction of the magnetic field caused by the magnetic field application unit.

The present disclosure can provide a power generation element in which a power generation amount is less likely to vary, a power generation system, and an encoder.

### BRIEF DESCRIPTION OF THE DRAWINGS

FIG. 1A is a cross-sectional view illustrating a schematic configuration of an encoder according to an exemplary embodiment.

FIG. 1B is a cross-sectional view illustrating a schematic configuration of a motor device including the encoder according to the exemplary embodiment.

FIG. 2 is a top view of a magnet in the encoder according to the exemplary embodiment.

FIG. 3 is a cross-sectional view illustrating a schematic configuration of a power generation element according to an exemplary embodiment.

FIG. 4 is a plan view of a ferrite member of the power generation element according to the exemplary embodiment.

FIG. 5 is a cross-sectional view illustrating a schematic configuration of a power generation element according to Comparative Example 1.

FIG. 6 is a cross-sectional view illustrating a schematic configuration of a power generation element according to Comparative Example 2.

FIG. 7 is a schematic diagram illustrating a circuit used for measuring the power generation amount of a power generation element.

FIG. 8 is a diagram illustrating the measurement results of the power generation amount of the power generation element according to Comparative Example 1.

FIG. 9 is a diagram illustrating the measurement results of the power generation amount of the power generation element according to the exemplary embodiment.

FIG. 10 is a diagram illustrating the measurement results of the power generation amount of the power generation element according to Comparative Example 2.

FIG. 11 is a diagram illustrating an example of a positional relationship between the power generation element according to the exemplary embodiment and a magnet.

FIG. 12 is a diagram illustrating an example of another positional relationship between the power generation element according to the exemplary embodiment and a magnet.

FIG. 13 is a cross-sectional view illustrating a schematic configuration of a power generation element according to a modification of the exemplary embodiment.

FIG. 14 is a plan view of a ferrite member of the power generation element according to the modification of the exemplary embodiment.

### DESCRIPTION OF EMBODIMENT

Exemplary embodiments of the present disclosure will be described below with reference to the drawings. Note that, each of the exemplary embodiments described below illustrates one specific example of the present disclosure. Therefore, numerical values, shapes, materials, constituent elements, arrangement positions and connection forms of the constituent elements, and the like shown in the following exemplary embodiments are illustrative and are not intended to limit the present disclosure. Therefore, among the constituent elements in the following exemplary embodiments, constituent elements not recited in the independent claims of the present disclosure are described as optional constituent elements.

Each of the drawings is a schematic diagram and not necessarily illustrated strictly. Thus, scales and the like are not necessarily matched in the respective drawings. In each drawing, substantially identical components are denoted by identical reference signs, and repetitive explanations thereof will be omitted or simplified.

In the present specification, a term indicating a relationship between elements such as parallel, a term indicating a shape of an element such as a rectangle, and a numerical range are not expressions representing only a strict meaning, but are expressions meaning to include a substantially equivalent range, for example, a difference of about several %.

### EXEMPLARY EMBODIMENT

Hereinafter, encoder 1, power generation system 5, and power generation element 100 according to an exemplary embodiment will be described.

### [Configuration]

First, configurations of encoder 1, power generation system 5, and power generation element 100 according to the present exemplary embodiment will be described.

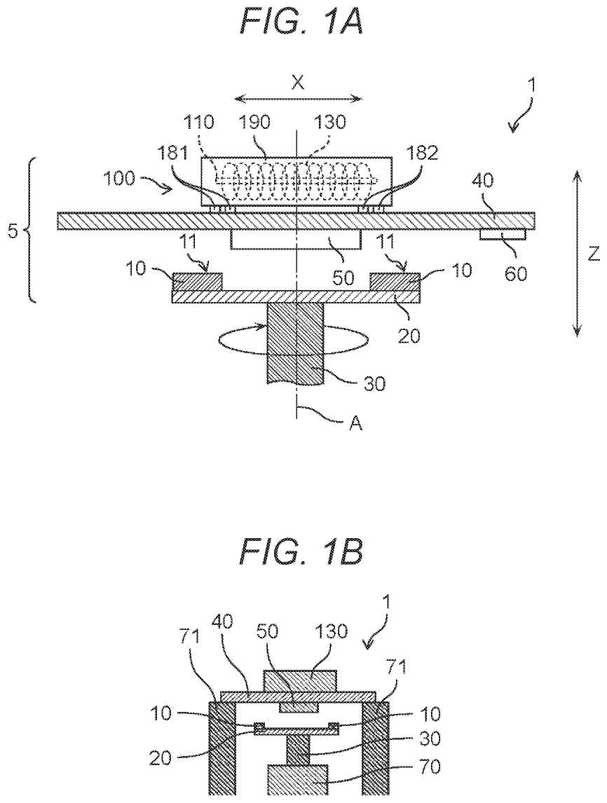

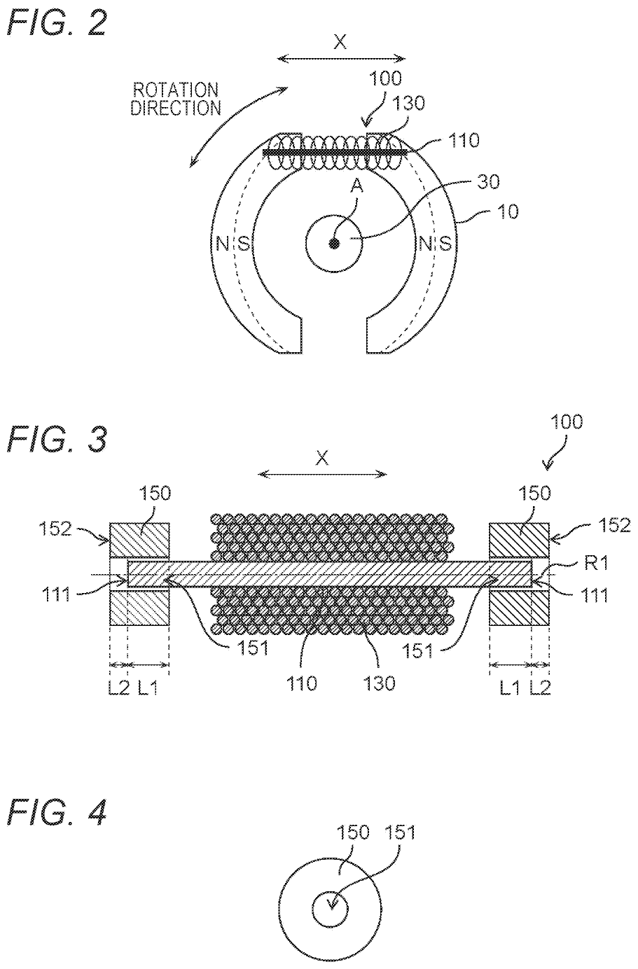

FIG. 1A is a cross-sectional view illustrating a schematic configuration of encoder 1 according to the present exemplary embodiment. FIG. 1B is a cross-sectional view illustrating a schematic configuration of a motor device including encoder 1 according to the present exemplary embodiment. FIG. 2 is a top view of magnet 10 in encoder 1 according to the present exemplary embodiment. In FIG. 1A, magnetic member 110 and coil 130 accommodated in housing 190 of power generation element 100 are schematically illustrated by broken lines. In FIG. 2, illustration of components other than magnet 10, rotary shaft 30, and magnetic member 110 and coil 130 in power generation element 100 is omitted for ease of viewing.

Encoder 1 illustrated in FIG. 1A is, for example, a rotary encoder used in combination with a motor such as a servomotor. Encoder 1 is, for example, an absolute encoder of a power generation system. Encoder 1 detects, for example, a rotation angle, a rotation amount, a rotation speed, and the like of rotary shaft 30 of a motor and the like based on an electric signal generated by power generation element 100. Encoder 1 includes power generation system 5 including magnet 10, rotating plate 20, substrate 40, and power generation element 100, control circuit 50, and memory 60. In encoder 1, power generation element 100 in power generation system 5 generates power because of a change in the magnetic field formed by magnet 10 due to the rotation of magnet 10, and outputs the generated electric power as an electric signal.

Rotating plate 20 is a plate-shaped member that rotates together with rotary shaft 30 that is a drive unit of a motor or the like. A central part of one principal surface of rotating plate 20 is attached to an end portion of rotary shaft 30 in an axial direction of rotary shaft 30 (a direction in which rotary shaft 30 extends). Rotating plate 20 extends in a direction orthogonal to the axial direction of rotary shaft 30. Rotating plate 20 rotates about rotation axis line A passing through the center of rotary shaft 30 and extending along the axial direction of rotary shaft 30. A rotating operation of rotary shaft 30 is synchronized with a rotating operation of a rotating device. A shape of rotating plate 20 in plan view is, for example, a circular shape. Rotating plate 20 is made of metal, resin, glass, ceramic, or the like, for example.

Rotary shaft 30 has a rod shape such as a columnar shape. The axis of rotary shaft 30 and rotation axis line A coincide with each other.

Magnet 10 is an example of a magnetic field application unit that applies an external magnetic field to the power generation element 100. Magnet 10 repeatedly reverses the direction of the magnetic field applied to power generation element 100. Magnet 10 is, for example, a plate-shaped magnet. Magnet 10 faces substrate 40 and is disposed on a principal surface of rotating plate 20, the principal surface being positioned opposite to rotary shaft 30. In the present exemplary embodiment, a pair of magnets 10 are provided on the same principal surface of rotating plate 20. A thickness direction of rotating plate 20 and a thickness direction of magnet 10 are the same, and are in a direction along the axis of rotary shaft 30. The pair of magnets 10 rotate together with rotating plate 20 about rotary shaft 30 as a rotation center (that is, rotation axis line A is set as the rotation axis). When the pair of magnets 10 rotate with the rotation of rotary shaft 30, a relative positional relationship between the pair of magnets 10 and power generation element 100 changes, and a magnetic field from the pair of magnets 10 applied to the power generation element 100 also changes. A rotation direction of the pair of magnets 10 is, for example, both clockwise direction and counterclockwise direction, but may be only one of clockwise direction and counterclockwise direction.

The pair of magnets 10 is disposed side by side at an interval on the same principal surface of the rotating plate 20 with the rotation axis line A of the rotary shaft 30 interposed therebetween. That is, the rotation axis line A of the rotary shaft 30 is positioned between the pair of magnets 10, and a space is formed. The pair of magnets 10 are disposed symmetrically with respect to the rotation axis line A. The pair of magnets 10 has the same shape.

Each of the pair of magnets 10 is disposed along the rotation direction of rotary shaft 30. A plan view shape of each of the pair of magnets 10 is an arc shape along the rotation direction of rotary shaft 30. Only one of the pair of magnets 10 may be provided on the principal surface of the rotating plate 20. Magnet 10 may be a magnet having another shape such as a donut shape, a disk shape, or a rod shape as long as the magnetic field applied to the power generation element 100 can be changed. Magnet 10 is, for example, a permanent magnet, but it may be an electromagnet.

As illustrated in FIG. 2, the N pole and the S pole of each of the pair of magnets 10 are aligned along a direction in which the pair of magnets 10 are aligned. The S pole and the N pole of each of the pair of magnets 10 are arranged in the same order. That is, each of the pair of magnets 10 is magnetized in the direction in which the pair of magnets 10 are aligned. Thus, each of the pair of magnets 10 generates a magnetic field along the direction in which the pair of magnets 10 are aligned.

The magnetic pole facing the rotation axis line A in one magnet 10 of the pair of magnets 10 is the S pole, and the magnetic pole facing the rotation axis line A in the other magnet 10 is the N pole. Thus, when the pair of magnets 10 are rotated by the rotation of the rotary shaft 30 and the positions of the pair of magnets 10 are exchanged with each other, the direction of the magnetic field formed by the pair of magnets 10 is reversed. The rotation of the pair of magnets 10 changes the magnetic field applied to power generation element 100. Specifically, the direction of the magnetic field applied to power generation element 100 is repeatedly reversed by the rotation of the pair of magnets 10.

As illustrated in FIG. 1A, substrate 40 is positioned so as to face the rotating plate 20 and magnet 10 with a space therebetween. That is, rotary shaft 30, rotating plate 20, magnet 10, and substrate 40 are aligned in this order along the axial direction of rotary shaft 30. Substrate 40 does not rotate together with magnet 10 and rotating plate 20. Substrate 40 has a plate shape whose thickness direction is in the axial direction of rotary shaft 30. A plan view shape of substrate 40 is, for example, a circular shape. For example, when viewed from the axial direction of rotary shaft 30, the centers of rotary shaft 30, rotating plate 20, and substrate 40 coincide with each other, and are in the positions of the rotation axis line A.

Substrate 40 is, for example, a wiring substrate on which electronic components such as power generation element 100, control circuit 50, and memory 60 are mounted. In the example illustrated in FIG. 1A, control circuit 50 and memory 60 are mounted on a principal surface of substrate 40, the principal surface facing magnet 10, and power generation element 100 is mounted on a principal surface of the substrate 40, the principal surface facing away from magnet 10. Substrate 40 is fixed to, for example, case 71 constituting a part of encoder 1, motor 70, or the like.

Power generation element 100 is positioned on the principal surface of substrate 40 facing away from magnet 10. Thus, the substrate 40 side as viewed from power generation element 100 is the magnet 10 side. Power generation element 100 is aligned with magnet 10 and rotating plate 20 along the axial direction of rotary shaft 30. Hereinafter, a direction indicated by arrow Z in which magnet 10, rotating plate 20, and power generation element 100 are aligned may be referred to as “alignment direction”. In the present exemplary embodiment, the alignment direction is also the axial direction of rotary shaft 30 and a normal direction of principal surface 11 of magnet 10. Power generation element 100 does not rotate together with magnet 10 and rotating plate 20.

The power generation element 100 is provided so as to face rotating plate 20 in the axial direction of rotary shaft 30. Power generation element 100 does not overlap with rotation axis line A and is disposed at a position shifted from rotation axis line A when viewed from the axial direction of rotary shaft 30. The power generation element 100 overlaps with a position through which magnet 10 passes when viewed from the axial direction of rotary shaft 30. The power generation element 100 extends along the principal surface of substrate 40 so as to extend in a tangential direction of the rotation direction of magnet 10.

Power generation element 100 generates power through a change in the magnetic field formed by magnet 10 due to the rotation of magnet 10, specifically, a reversal of the direction of the magnetic field, and outputs the generated electric power. A winding axis direction of coil 130 of power generation element 100 (a longitudinal direction of magnetic member 110) is a direction in which power generation element 100 extends. The winding axis direction of coil 130 is a direction indicated by arrow X in the drawing. Hereinafter, the winding axis direction of coil 130 indicated by arrow X in the drawing may be simply referred to as “winding axis direction”.

Power generation element 100 includes, for example, magnetic member 110, coil 130, and ferrite member 150 (see FIG. 3; omitted in FIGS. 1A and 2), terminals 181, 182, and housing 190.

Details of magnetic member 110, coil 130, and ferrite member 150 will be described later. Magnetic member 110 is a magnetic member that produces a large Barkhausen effect, and a power generation pulse is generated in coil 130 wound around magnetic member 110. Disposition of power generation element 100 is not particularly limited as long as power generation element 100 is positioned in a region to which a magnetic field generated by magnet 10 is applied and is disposed to generate a power generation pulse by using the reversal in direction of the magnetic field due to the rotation of rotary shaft 30.

Terminals 181, 182 are members for electrically connecting power generation element 100 and substrate 40. Terminals 181, 182 are positioned in the vicinity of end portions facing substrate 40 in power generation element 100. Magnet 10 is disposed in the direction of terminals 181, 182 as viewed from power generation element 100. Terminal 181 is electrically connected to one end of a conductive wire constituting coil 130, and terminal 182 is electrically connected to the other end of the conductive wire. That is, coil 130 and substrate 40 are electrically connected via terminals 181, 182.

Housing 190 accommodates and supports magnetic member 110, coil 130, and ferrite member 150. Magnetic member 110, coil 130, and ferrite member 150 are, for example, embedded in resin or the like in housing 190. Housing 190 also accommodates a part of terminals 181, 182. Housing 190 is open to the magnet 10 side of power generation element 100, for example. Housing 190 is fixed to substrate 40 by, for example, a fixing member (not illustrated) or the like.

Control circuit 50 is positioned on the principal surface of substrate 40 facing magnet 10. Control circuit 50 is electrically connected to power generation element 100. Control circuit 50 acquires an electric signal such as a power generation pulse generated by power generation element 100, and detects (calculates) a rotation angle, a rotation amount, a rotation speed, and the like of rotary shaft 30 of a motor and the like based on the acquired electric signal. Control circuit 50 is, for example, an integrated circuit (IC) package or the like.

Memory 60 is positioned on the principal surface of substrate 40 facing magnet 10. Memory 60 is connected to control circuit 50. Memory 60 is a nonvolatile memory such as a semiconductor memory that stores a result detected by control circuit 50. Next, a detailed configuration of power generation element 100 according to the present exemplary embodiment will be described.

FIG. 3 is a cross-sectional view illustrating a schematic configuration of power generation element 100 according to the present exemplary embodiment. FIG. 3 illustrates a cross section taken along the alignment direction so as to pass through winding axis R1 of coil 130. Illustration of terminal 181, terminal 182, and housing 190 is omitted in FIG. 3 for ease of viewing. The same applies to the drawings of the power generation elements described below.

As illustrated in FIG. 3, power generation element 100 includes magnetic member 110, coil 130, and ferrite member 150.

Magnetic member 110 is a magnetic member that generates a large Barkhausen effect because of a change in an external magnetic field formed by magnet 10 and the like. Magnetic member 110 is, for example, a composite magnetic wire having different magnetic characteristics between a central part and an outer peripheral part in a radial direction (direction perpendicular to winding axis R1) such as a Wiegand wire. In the composite magnetic wire, one of the central part and the outer peripheral part is a hard magnetic part, and the other is a soft magnetic part.

The composite magnetic wire has magnetic characteristics in which the magnetization direction changes due to application of a relatively small external magnetic field in the soft magnetic part, and the magnetization direction does not change in the hard magnetic part unless a relatively large external magnetic field is applied. When a relatively large external magnetic field sufficient to reverse the magnetization direction of the hard magnetic part of the composite magnetic wire is applied in a longitudinal direction of the composite magnetic wire, the magnetization direction of the hard magnetic part of the composite magnetic wire and the magnetization direction of the soft magnetic part are aligned in the same direction. Thereafter, even when the direction of the external magnetic field applied to the composite magnetic wire is reversed, the magnetization direction of the hard magnetic part and the magnetization direction of the soft magnetic part are not reversed while the external magnetic field is small due to the influence of the hard magnetic part. When the external magnetic field in which the direction is further reversed is increased, the magnetization direction of the soft magnetic part is rapidly reversed when a predetermined threshold value is exceeded. Such a phenomenon in which the magnetic field is rapidly reversed is also called a large Barkhausen jump. This causes a rapid change of the magnetic flux density of the composite magnetic wire and generates electric power (power generation pulse) in coil 130 wound around the composite magnetic wire.

Magnetic member 110 is not limited to the composite magnetic wire such as a Wiegand wire, and may be any magnetic member that produces a large Barkhausen effect by having a hard magnetic part and a soft magnetic part having different magnetic characteristics. In magnetic member 110, for example, the hard magnetic part and the soft magnetic part are arranged in a direction intersecting (for example, orthogonal to) the winding axis direction, and the hard magnetic part and the soft magnetic part are present so as to extend in the winding axis direction, which generates a large Barkhausen effect. Magnetic member 110 may be a magnetic member having a structure in which thin films having different magnetic characteristics are stacked.

Magnetic member 110 is, for example, a wire-shaped member extending along the winding axis of coil 130. A cross-sectional shape of magnetic member 110 cut in a radial direction is, for example, a circular shape or an elliptical shape, but may be another shape such as a rectangular shape or a polygonal shape. In the winding axis direction, the length of magnetic member 110 is longer than the length of coil 130.

Coil 130 is a coil in which a conductive wire constituting coil 130 is wound around magnetic member 110. Specifically, coil 130 passes through a center of magnetic member 110 and is wound along winding axis R1 extending in the longitudinal direction of magnetic member 110. In the winding axis direction, coil 130 is positioned between two end surfaces 111 on both sides of magnetic member 110. Coil 130 is positioned between two ferrite members 150. Coil 130 and ferrite member 150 are separated from each other. Coil 130 may be in contact with ferrite member 150 by increasing the number of windings and extending in the winding axis direction.

Ferrite member 150 is provided at an end portion of magnetic member 110 so as to be aligned with coil 130 along the winding axis of coil 130. In the present exemplary embodiment, two ferrite members 150 are provided at both end portions of magnetic member 110, respectively. Two ferrite members 150 face each other with coil 130 interposed therebetween and have a symmetrical shape. Hereinafter, one of two ferrite members 150 will be mainly described, but the same description is applied to the other.

FIG. 4 is a plan view of ferrite member 150. FIG. 4 illustrates a plan view shape of ferrite member 150 viewed from the outside along the winding axis direction.

As illustrated in FIGS. 3 and 4, ferrite member 150 is a tubular member in which opening 151 is formed. Ferrite member 150 is, for example, ferrite beads made of a soft magnetic material. Ferrite member 150 is provided for magnetism collection of magnetic flux from magnet 10, stabilization of magnetic flux in magnetic member 110, and the like. Ferrite member 150 is, for example, softer magnetic than the soft magnetic part of magnetic member 110, that is, the ferrite member has a lower coercive force than the soft magnetic part of magnetic member 110.

Ferrite member 150 is provided with opening 151 into which a part of magnetic member 110 is inserted. Opening 151 is a through hole penetrating ferrite member 150 along the winding axis direction. Opening 151 is positioned at the center of ferrite member 150 when viewed along the winding axis direction. The shape of each of the outer periphery of ferrite member 150 and opening 151 when viewed along the winding axis direction is, for example, a circular shape. Thus, ferrite member 150 has, for example, a cylindrical shape.

The end portion of magnetic member 110 in the winding axis direction is positioned in opening 151 and covered with ferrite member 150. Thus, outer end surface 152 of ferrite member 150 is positioned on the outer side than end surface 111 of magnetic member 110 in the winding axis direction. That is, in the winding axis direction, end surface 152 is positioned on the side opposite to coil 130 as viewed from end surface 111. Although details will be described later, with such a configuration, the power generation amount of power generation element 100 is less likely to vary. In the present specification, the “outer side” in the winding axis direction is a “position more distant” from the center of magnetic member 110 in the winding axis direction.

In the winding axis direction, length L1 of the region of ferrite member 150 positioned on the inner side than end surface 112 is longer than length L2 of the region of ferrite member 150 positioned on the outer side than end surface 112. As a result, the region where ferrite member 150 covers magnetic member 110 becomes large, and the power generation amount of power generation element 100 can be stabilized. In the present specification, the “inner side” in the winding axis direction is a “position closer” to the center of magnetic member 110 in the winding axis direction.

### Effects and the Like

Next, effects and the like of power generation element 100 according to the present exemplary embodiment will be described with reference to a power generation element according to Comparative Example.

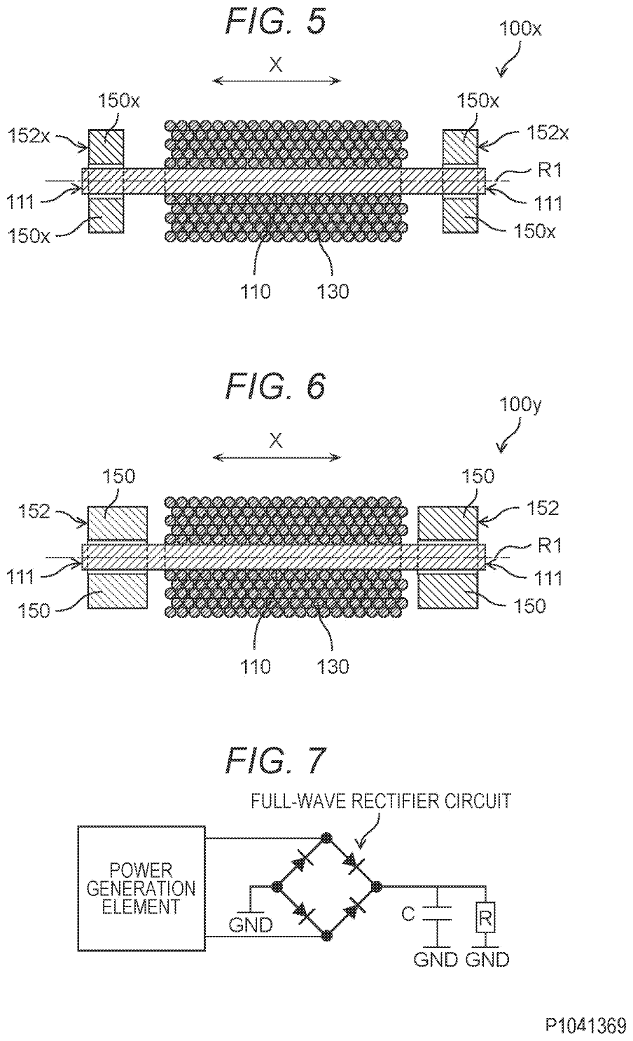

FIG. 5 is a cross-sectional view illustrating a schematic configuration of power generation element 100x according to Comparative Example 1. FIG. 6 is a cross-sectional view illustrating a schematic configuration of power generation element 100y according to Comparative Example 2.

As illustrated in FIG. 5, power generation element 100x according to Comparative Example 1 includes ferrite member 150x instead of ferrite member 150 as compared with power generation element 100. The length of ferrite member 150x in the winding axis direction is shorter than that of ferrite member 150. Unlike power generation element 100, the position of outer end surface 152x of ferrite member 150x in the winding axis direction is on the inner side than the position of the outer end surface of ferrite member 150 in the winding axis direction. Thus, end surface 152x is positioned on the inner side than end surface 111 of magnetic member 110 in the winding axis direction. That is, the end portion on the outer side than end surface 152x of magnetic member 110 in the winding axis direction is not covered with ferrite member 150x.

As illustrated in FIG. 6, in power generation element 100y according to Comparative Example 2, ferrite member 150 is positioned inside as compared with power generation element 100 in the winding axis direction. In power generation element 100y, end surface 152 of ferrite member 150 is positioned on the inner side than end surface 111 of magnetic member 110 in the winding axis direction. Thus, in power generation element 100y, the end portion on the outer side than end surface 152 of magnetic member 110 in the winding axis direction is not covered with ferrite member 150.

Here, the results of measuring the power generation amount of power generation elements using power generation element 100, power generation element 100x, and power generation element 100y will be described.

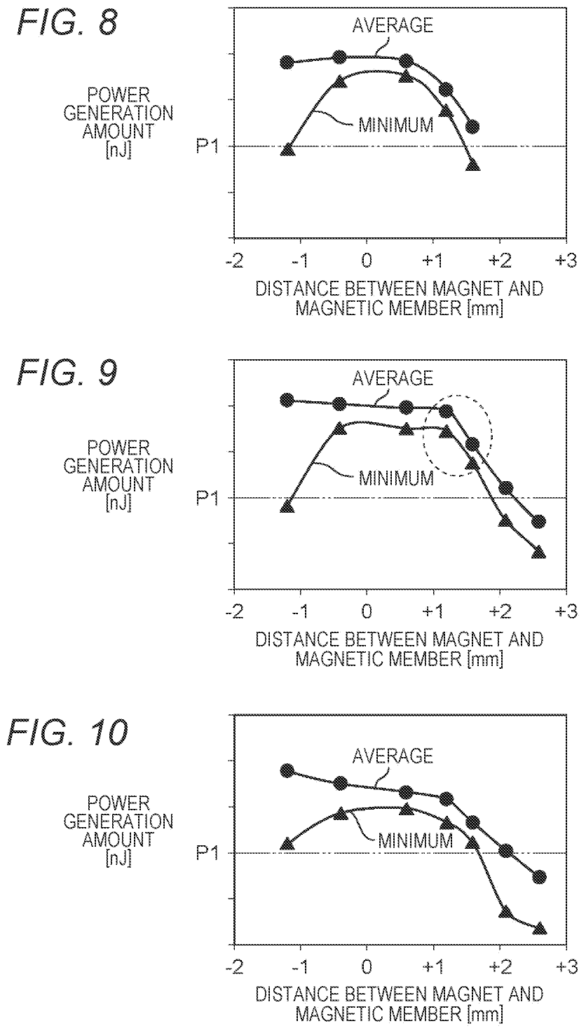

FIG. 7 is a schematic diagram illustrating a circuit used for measuring a power generation amount of a power generation element. In the measurement of the power generation amount of the power generation element, the power generation element and magnet 10 were disposed so as to have a positional relationship as illustrated in FIGS. 1A and 2, and the direction of the magnetic field from magnet 10 applied to the power generation element was repeatedly changed. In addition, the power generation element was connected to a circuit as illustrated in FIG. 7. Specifically, the output of the power generation element was connected to a full-wave rectifier circuit connected to capacitor C and resistor R. For each reversal of the direction of the external magnetic field, the peak of voltage V after rectification of the power generation pulse generated by the power generation element was measured, and the power generation amount was defined as (½)CV². The power generation amount was measured 2500 times, and an average value and a minimum value of the measured power generation amounts of 2500 times were derived. In addition, the power generation amount was measured under distance conditions where the distance between magnet 10 and magnetic member 110 was set to −1.2 mm, −0.4 mm, +0.6 mm, +1.2 mm, +1.6 mm, +2.1 mm, and +2.6 mm with respect to a reference distance assumed to stably generate power. In the measurement using power generation element 100x, the measurement was not performed under the distance conditions of +2.1 mm and +2.6 mm. The measurement results are shown in FIGS. 8 to 10.

FIG. 8 is a diagram illustrating the measurement results of the power generation amount of power generation element 100x according to Comparative Example 1. FIG. 9 is a diagram illustrating the measurement results of the power generation amount of power generation element 100 according to the exemplary embodiment. FIG. 10 is a diagram illustrating the measurement results of the power generation amount of power generation element 100y according to Comparative Example 2. In FIGS. 8 to 10, the horizontal axis is an axis indicating the difference in distance between magnet 10 and magnetic member 110 with respect to the reference distance. The distance between magnet 10 and magnetic member 110 becomes longer toward the right side of the horizontal axis. In FIGS. 8 to 10, the vertical axis is an axis indicating the power generation amount measured by the above-described method. Reference value P1 (two-dot chain line in FIGS. 8 to 10) was set as a reference power generation amount with which an electric signal can be stably detected.

As illustrated in FIG. 8, when power generation element 100x according to Comparative Example 1 was used for power generation, the longer the distance between magnet 10 and magnetic member 110, the lower the power generation amount, and under the distance condition of +1.6 mm, the minimum value of the power generation amount was below reference value P1.

On the other hand, as illustrated in FIG. 9, when power generation element 100 according to the exemplary embodiment was used for power generation, the power generation amount increased more than that of power generation element 100x under the distance conditions of +1.2 mm and +1.6 mm. Since the external magnetic field applied to the power generation element becomes weaker as the distance between magnet 10 and magnetic member 110 becomes longer, it can be said that the power generation amount of power generation element 100 is less likely to decrease even when the applied external magnetic field becomes weaker. Thus, even when the external magnetic field applied to power generation element 100 becomes weak due to the influence of some external environment during use, power generation element 100 is less likely to decrease in power generation amount, and can stably generate power. That is, in power generation element 100, the strength range of the applied magnetic field that can stably generate power is wide, and the power generation amount is less likely to vary.

The reason of the wider intensity range of the applied magnetic field in which power generation element 100 can stably generate power than that in power generation element 100x is considered as follows.

The ferrite member more easily collects magnetism than magnetic member 110. Thus, magnetic flux from magnet 10 is more likely to gather on the ferrite member than on magnetic member 110. As a result, magnetic member 110 is magnetized mainly by the magnetic field via the ferrite member.

In power generation element 100x, end surface 111 of magnetic member 110 is positioned on the outer side than end surface 152x of ferrite member 150x in the winding axis direction. Thus, in the winding axis direction, the end portion of magnetic member 110 on the outer side than end surface 152x is hardly magnetized, or is magnetized in the direction opposite to the central part of magnetic member 110 and ferrite member 150x due to the influence of the central part of magnetized magnetic member 110 and ferrite member 150x. Thus, the magnetic flux density of the entire magnetized magnetic member 110 is less likely to increase. It is considered that, as a result, when the external magnetic field applied to power generation element 100 becomes weak, the power generation amount greatly decreases.

On the other hand, in power generation element 100, end surface 111 of magnetic member 110 is positioned on the inner side than end surface 152 of ferrite member 150 in the winding axis direction and is covered with ferrite member 150. Thus, magnetic member 110 is magnetized up to the end portion, and the magnetic flux density of the entire magnetic member 110 that is magnetized increases. It is considered that, as a result, the power generation amount is less likely to decrease even when the external magnetic field applied to power generation element 100 becomes weak.

As illustrated in FIG. 10, when power generation element 100y according to Comparative Example 2 using the same ferrite member 150 as power generation element 100 was used for power generation, the power generation amount was smaller than that of power generation element 100 under the distance conditions of +1.2 mm and +1.6 mm. It is considered that the power generation amount decreased also in power generation element 100y because end surface 111 of magnetic member 110 was positioned on the outer side than end surface 152 of ferrite member 150 in the winding axis direction.

In addition, even when the same ferrite member 150 as power generation element 100 according to the exemplary embodiment is used, the power generation amount of power generation element 100y is lower than that of power generation element 100. From this, it can be said that the difference in the power generation amount between power generation element 100x and power generation element 100 according to Comparative Example 1 is not due to the difference in the length in the winding axis direction between ferrite member 150x and ferrite member 150. That is, in power generation element 100, since end surface 111 of magnetic member 110 is positioned on the inner side than end surface 152 of ferrite member 150 in the winding axis direction, the amount of power generation is less likely to decrease, and variation in the amount of power generation is less likely to occur even when the strength of the external magnetic field changes. Thus, for example, even when the position of magnet 10 is shifted during the use of encoder 1, power generation element 100 is less likely to reduce the power generation amount, and can output stably generated electric power as an electric signal.

As illustrated in FIGS. 8 to 10, under the distance condition of −1.2 mm where the distance between the power generation element and magnet 10 is the shortest, the minimum value of the power generation amount is low. There is a possibility that this is because the magnetic field applied to magnetic member 110 became too strong, the occurrence of rapid reversal of the magnetization direction in the soft magnetic part became unstable, and the power generation amount varied for each reversal of the external magnetic field.

Next, the magnetic field applied to power generation element 100 by the magnetic field application unit such as a magnet will be described.

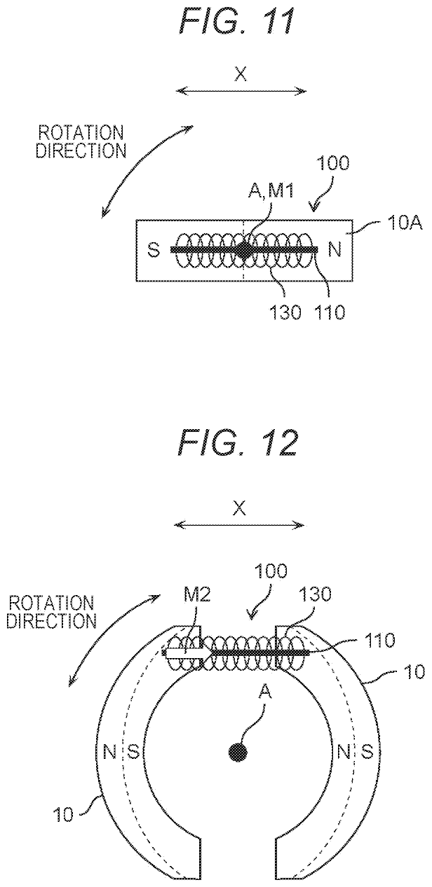

FIGS. 11 and 12 are diagrams illustrating an example of a positional relationship between power generation element 100 and a magnet. FIGS. 11 and 12 illustrate diagrams when power generation element 100 and the magnet are arranged along rotation axis line A as viewed from the direction along the rotation axis line A, like encoder 1 described above. In FIGS. 11 and 12, illustration of components other than the magnet and magnetic member 110 and coil 130 in power generation element 100 is omitted for ease of viewing.

In the example illustrated in FIG. 11, magnet 10A having a rod shape rotates about rotation axis line A as the rotation axis. Magnet 10A and power generation element 100 are disposed so as to overlap each other when viewed along the rotation axis line A. When viewed along the rotation axis line A, rotation axis line A, which is the rotation axis of magnet 10A, the center of magnet 10A, and center M1 of power generation element 100 are at the same position. The S pole and the N pole of magnet 10A are disposed symmetrically with respect to rotation axis line A. In the example illustrated in FIG. 11, the position in power generation element 100 to which the magnetic field from magnet 10A is most strongly applied is center M1 of power generation element 100. Thus, even when magnet 10A rotates, the S pole and the N pole of magnet 10A move on the circumference about rotation axis line A while maintaining the symmetrical positional relationship with respect to rotation axis line A, and thus the position to which the magnetic field from magnet 10A is most strongly applied does not move. That is, the magnetic field applied from magnet 10A is always the strongest at center M1 of power generation element 100. When magnet 10A rotates, the direction of the magnetic field applied from magnet 10A is reversed at center M1 of power generation element 100 earlier than at the end portion of power generation element 100. That is, when the direction of the external magnetic field is reversed, the magnetization direction of magnetic member 110 is first reversed at the center of magnetic member 110, and a range of reversal spreads from the center of magnetic member 110 to the end portion of magnetic member 110.

In the application of the magnetic field to power generation element 100 as illustrated in FIG. 11, the influence of the magnetization of the central part of magnetic member 110 is large and the influence of the magnetization of the end portion of magnetic member 110 is small in the power generation of power generation element 100. Thus, the effect of improving the power generation amount of power generation element 100 with magnetization up to the end portion of magnetic member 110 described in the measurement result of the power generation amount described above is also exhibited in the positional relationship between magnet 10A and power generation element 100 illustrated in FIG. 11, but the effect may be small.

FIG. 12 illustrates an example having the same positional relationship as that of power generation element 100 and the pair of magnets 10 in encoder 1 (power generation system 5) described above. That is, when viewed along rotation axis line A, the pair of magnets 10 and power generation element 100 are disposed out of rotation axis line A which is the rotation center. In the example illustrated in FIG. 12, when the pair of magnets 10 rotate, the pair of magnets 10 having an arc shape move along the longitudinal direction of power generation element 100 when viewed along rotation axis line A. Thus, when the pair of magnets 10 rotate, the position of power generation element 100 to which the magnetic field from the pair of magnets 10 is most strongly applied moves from one end portion toward the center of power generation element 100 and further moves from the center toward the other end portion as indicated by outlined arrow M2. Therefore, when the pair of magnets 10 rotate, the position where the direction of the magnetic field applied from the pair of magnets 10 is reversed also moves from one end portion toward the center of power generation element 100 and further moves from the center toward the other end portion as indicated by outlined arrow M2.

In the application of the magnetic field to power generation element 100 in the example illustrated in FIG. 12, the influence of the magnetization of the end portion of magnetic member 110 becomes larger in the power generation of power generation element 100 than in the example illustrated in FIG. 11. Thus, the end portion of magnetic member 110 described in the measurement result of the power generation amount is magnetized, and the effect of improving the power generation amount of power generation element 100 is remarkably exhibited. That is, in power generation system 5 in which the pair of magnets 10 being rotating move the position where the direction of the magnetic field to be applied is reversed from an end portion to the center of power generation element 100 in the winding axis direction as illustrated in FIGS. 1A and 2, the power generation amount is less likely to vary.

### Modifications

Next, a modification of the exemplary embodiment will be described. In the following description of the modification, differences from the exemplary embodiment will be mainly described, and description of common points will be omitted or simplified.

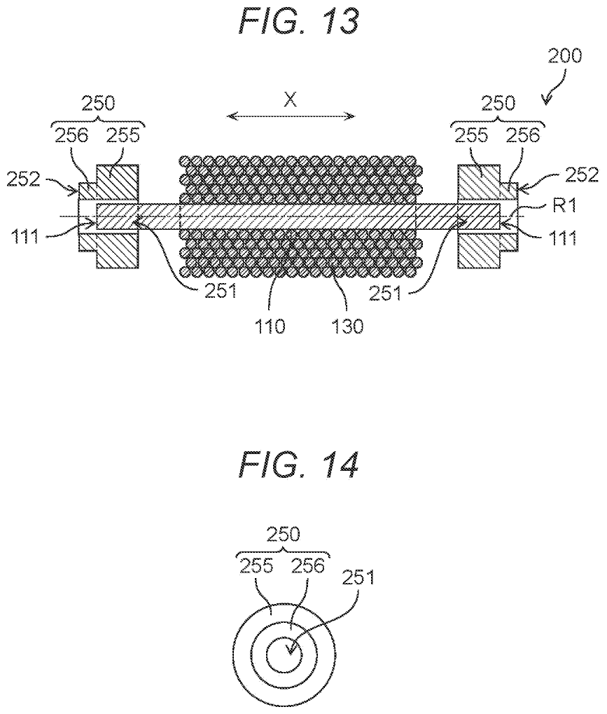

FIG. 13 is a cross-sectional view illustrating a schematic configuration of power generation element 200 according to the present modification. Power generation element 200 is used, for example, instead of power generation element 100 of encoder 1 described above.

As illustrated in FIG. 13, power generation element 200 is different from power generation element 100 in that ferrite member 250 is provided instead of ferrite member 150.

FIG. 14 is a plan view of ferrite member 250. FIG. 14 illustrates a plan view shape of ferrite member 250 viewed from the outside along the winding axis direction.

As illustrated in FIGS. 13 and 14, ferrite member 250 includes body 255 and projection 256 that is thinner than body 255 and extends outward from body 255 along the winding axis direction. Body 255 and projection 256 are names attached to two portions formed by processing one member made of the same material, for example. Ferrite member 250 may be formed by connecting body 255 and projection 256 formed of different members.

Ferrite member 250 is provided with opening 251 that penetrates body 255 and projection 256 along the winding axis direction. Opening 251 is open on the coil 130 side of body 255. Opening 251 is positioned at the center of body 255 and projection 256 when viewed along the winding axis direction. Opening 251 may be provided in at least body 255 of ferrite member 250, and it does not have to be provided in projection 256.

The end portion of magnetic member 110 in the winding axis direction is positioned in opening 251 and covered with ferrite member 250. Thus, outer side end surface 252 of ferrite member 250 is positioned on the outer side than end surface 111 of magnetic member 110 in the winding axis direction. In ferrite member 250, end surface 252 is provided on projection 256.

The shape of the outer periphery of body 255, the outer periphery of projection 256, and opening 251 as viewed along the winding axis is, for example, circular. Thus, body 255 and projection 256 each have a cylindrical shape. The outer diameter of projection 256 is smaller than the outer diameter of body 255.

In the winding axis direction, the length of body 255 is longer than the length of projection 256, for example. As a result, body 255 thicker than projection 256 is enlarged, and the magnetism collection force of ferrite member 250 can be increased.

For example, the entire body 255 is positioned inside end surface 111 of magnetic member 110 in the winding axis direction. A part of body 255 may be positioned on the outer side than end surface 111 of magnetic member 110 in the winding axis direction.

Projection 256 protrudes, for example, from an end portion of body 255 having a cylindrical shape toward the outside in the winding axis direction by forming a step. A side surface of projection 256 extends in a direction parallel to the winding axis direction. The side surface of projection 256 may have a tapered shape inclined with respect to the winding axis direction. That is, projection 256 may have a shape in which the tip side is narrowed.

In this manner, in power generation element 200, ferrite member 250 has narrow projection 256 protruding outward in the winding axis direction. As a result, for example, projection 256 can enter the resin in which magnetic member 110, coil 130, and ferrite member 250 are embedded, or when housing 190 is provided with a recess or a hole, projection 256 can be fitted into the recess or the hole. Thus, the composite body of magnetic member 110, coil 130, and ferrite member 250 is easily supported and fixed to housing 190, and the packaging property of power generation element 200 can improve.

### Other Exemplary Embodiments

Although the power generation element, the power generation system, and the encoder according to the present disclosure have been described above based on the exemplary embodiments, the present disclosure is not limited to the above exemplary embodiments. The present disclosure also includes a mode obtained by applying various modifications conceived by those skilled in the art to each of the above exemplary embodiments, and a mode realized by freely combining components and functions in each exemplary embodiment without departing from the gist of the present disclosure.

For example, in the above-described exemplary embodiment, the opening of the ferrite member is a through hole, but the opening is not limited to this configuration. The opening of the ferrite member may be a bottomed hole that is open only on the inner side in the winding axis direction, not having a penetrated part. That is, a part of the ferrite member may also be disposed outside the end surface of the magnetic member.

In addition, for example, in the above-described exemplary embodiment, the position of the power generation element is fixed, and the direction of the magnetic field applied to the power generation element is repeatedly reversed by the rotation of the magnet with the rotary shaft, but the present disclosure is not limited to this configuration. The position of the magnet may be fixed, and the direction of the magnetic field applied to the power generation element may be repeatedly reversed because of the power generation element rotating with the rotation of the rotary shaft.

In addition, for example, in the above exemplary embodiment, a rotary encoder used in combination with a motor has been described as an example, but the present disclosure is not limited to this configuration. The technology of the present disclosure can also be applied to a linear encoder.

### INDUSTRIAL APPLICABILITY

The power generation element, the power generation system, and the encoder according to the present disclosure are useful for equipment, devices, and the like that rotate or move linearly, such as motors.

### REFERENCE MARKS IN THE DRAWINGS

1: encoder
10, 10A: magnet
20: rotating plate
30: rotary shaft
40: substrate
50: control circuit
60: memory
100, 100x, 100y, 200: power generation element
110: magnetic member
130: coil
150, 150x, 250: ferrite member
255: body
256: projection
151, 251: opening
181, 182: terminal
190: housing

1. A power generation element comprising:
a magnetic member that produces a large Barkhausen effect because of a change in an external magnetic field;
a coil wound around the magnetic member; and
a ferrite member disposed side by side with the coil along a winding axis of the coil and including an opening into which a part of the magnetic member is inserted,
wherein the ferrite member includes an end portion positioned farther from the coil along the winding axis than an end portion of the magnetic member is.

2. The power generation element according to claim 1, wherein the ferrite member includes a body and a projection that is thinner than the body and extends outward from the body along the winding axis.

3. The power generation element according to claim 2, wherein the body has a length longer than a length of the projection in a direction along the winding axis.

4. The power generation element according to any one of claims 1 to 3, wherein
the magnetic member has a wire shape extending along the winding axis, and
the opening penetrates the ferrite member along the winding axis.

5. The power generation element according to any one of claims 1 to 4, wherein a length of a region of the ferrite member, the region being positioned on an inner side than the end portion of the magnetic member in the winding axis direction, is longer than a length of a region of the ferrite member positioned on an outer side than the end portion of the magnetic member.

6. A power generation system comprising:
the power generation element according to any one of claims 1 to 5; and
a magnetic field application unit that applies a magnetic field to the power generation element and repeatedly reverses a direction of the magnetic field applied to the power generation element,
wherein the power generation element generates power by using a reversal of the direction of the magnetic field caused by the magnetic field application unit.

7. The power generation system according to claim 6, wherein the magnetic field application unit moves a position where the direction of the magnetic field is reversed from an end portion of the power generation element toward a center in the winding axis direction.

8. An encoder comprising the power generation system according to claim 6 or 7, wherein the power generation element outputs the power generated by using the reversal of the direction of the magnetic field caused by the magnetic field application unit.
